(19) United States
(12) Patent Application Publication
(10) Pub. No.: US 2020/0265088 A1
(43) Pub. Date: Aug. 20, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kazunori HORIKIRI, Tokyo (JP)

(73) Assignee: FUJI XEROX CO., LTD., Tokyo (JP)

(21) Appl. No.: 16/538,842

(22) Filed: Aug. 13, 2019

(30) Foreign Application Priority Data
Feb. 19, 2019 (JP) 2019-027165

(51) Int. Cl. G06F 16/901; G06F 16/242; G06F 16/9038

(52) U.S. Cl. CPC G06F 16/901; G06F 16/9038; G06F 16/2423

(57) ABSTRACT

An information processing apparatus includes a display controller and an output unit. The display controller controls display of first information disposed on a screen, and controls display of second information illustrating an attribute of the first information. The output unit outputs multiple pieces of first information in accordance with a structure in the second information. The pieces of first information match the second information in terms of the attribute and form the structure.

### CROSS-REFERENCE TO RELATED APPLICATIONS

This application is based on and claims priority under 35 USC 119 from Japanese Patent Application No. 2019-027165 filed Feb. 19, 2019.

### BACKGROUND

### (i) Technical Field

The present disclosure relates to an information processing apparatus and a non-transitory computer readable medium.

### (ii) Related Art

Japanese Patent No. 3132606 discloses an apparatus including an input unit, an attribute representation storage unit, a graph representation storage unit, an attribute-representation/graph-representation conversion unit including a first conversion unit and a second conversion unit, and an output unit. The input unit receives relational information for a database. The attribute representation storage unit stores information that is received by the input unit and that is expressed as relational information in a distance space such as an n-dimensional Euclidean space. The graph representation storage unit stores information that is received by the input unit and that is expressed as relational information having a graph structure formed of nodes and arcs. The first conversion unit receives, from the attribute representation storage unit, information expressed in tuples describing attribute values, converts the tuples, describing attribute values, into nodes of the graph structure, and links, by using arcs, the nodes satisfying a condition given to the conversion. Thus, the first conversion unit expresses the information as relational information in the graph structure, and stores the result in the graph representation storage unit. The second conversion unit receives, from the graph representation storage unit, information expressed by using nodes and arcs, converts the nodes into tuples, and gives attribute values to the tuples according to a condition given to the conversion. Thus, the second conversion unit expresses the information as tuples describing attribute values, and stores the result into the attribute representation storage unit. The output unit outputs the information, which is stored in the attribute representation storage unit, or the information, which is stored in the graph representation storage unit, in accordance with a search access.

Japanese Patent No. 4132137 discloses a method, used by a mediator, of integrating information from a database system by using a computer system. The method includes a) the mediator receiving a first database example file including values stored in the format of a first database schema used in a database system and the attribute names of the values, b) the mediator receiving a second database example file including values stored in the format of a second database schema used in a computer system and the attribute names of the values, the values of the second database example file corresponding to the values of the first database example file, c) the mediator generating a translation map between the attribute names of the first database schema and the attribute name of the second database schema on the basis of the first database example file and the second database example file, and d) the mediator, in accordance with the generated translation map, translating information queries, which are issued from the computer system and composed using the attribute name of the second database schema, to information queries, which are issued to the database system and composed using the attribute names of the first database schema, and translating responses, which are transmitted from the database system and composed using the attribute names of the first database schema, to responses, which are transmitted to the computer system and composed using the attribute names of the second database schema.

Japanese Patent No. 4381776 discloses an information sharing system. In the information sharing system, a client apparatus is connected to a server over a communication network; electronic information is transmitted from the client apparatus to the server; electronic sticky note information is pasted to the electronic information; and given processes are performed. The client apparatus includes a display unit that displays visual information, an input unit that is used to input visual information displayed on the display unit, a content generating unit that generates content from the visual information input by using the input unit, and a transmission unit that transmits, to the server, the content generated by the content generating unit. The server includes a reception unit, a content conversion unit, a sticky note editing unit, a storage unit, and a sticky note accumulation unit. The reception unit receives the content generated by the content generating unit in the client apparatus. The content conversion unit converts the content, which is generated by the content generating unit, to a format in which sticky notes may be pasted to the content. The sticky note editing unit edits sticky note information for the content having obtained through the conversion into the format in which sticky notes may be pasted to the content. The storage unit stores a table for managing the content, the sticky note information pasted to the content, and coordinate positions for displaying the sticky note information. The sticky note accumulation unit generates a list from the sticky note information associated with the content, calculates the display positions of the sticky note information for the content on the basis of the coordinate positions of the sticky note information, and generates a sticky note accumulation page displaying icons indicating approximate display positions of the sticky note information in association with the listed sticky note information.

Japanese Patent No. 5147952 discloses a system model conversion method of converting a system model by using a computer in order to facilitate analysis and editing of the system model. The computer includes a graph model storage unit for storing a graph model which indicates a system model that has a graph-format data structure and that is formed of multiple model elements. The method includes receiving input of a conversion process description including a description about the structure of a multi-dimensional data model and extraction queries for extracting the model components; and generating a multi-dimensional data model from the graph model stored in the graph model storage unit on the basis of the input conversion process description. The multi-dimensional data model is formed of a root block table and multiple block tables obtained by hierarchizing the root block table. To each of the block table and the block tables of the multi-dimensional data model, block extraction queries for specifying which block is to be extracted from the graph model as a record of the table are given. The method further includes, for each of the root block table and the block tables, adding the block of the graph model extracted on the basis of the given block extraction queries, as a record.

### SUMMARY

Aspects of non-limiting embodiments of the present disclosure relate to an information processing apparatus and a non-transitory computer readable medium. In the case where first information and second information, which illustrates the attributes of the first information, are displayed, the information processing apparatus and the non-transitory computer readable medium enable the first information to be output according to the structure in the second information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a display controller and an output unit. The display controller controls display of first information disposed on a screen, and controls display of second information illustrating an attribute of the first information. The output unit outputs multiple pieces of first information in accordance with a structure in the second information. The pieces of first information match the second information in terms of the attribute and form the structure.

### BRIEF DESCRIPTION OF THE DRAWINGS

Exemplary embodiment of the present disclosure will be described in detail based on the following figures, wherein:

FIG. 1 is a conceptual diagram illustrating an exemplary module configuration according to the present exemplary embodiment;

FIG. 2 is a diagram for describing an exemplary system configuration using the present exemplary embodiment;

FIGS. 3A to 3C are diagrams for describing an example of use of electronic-sticky-note terminals and an information processing apparatus in a meeting room or the like where the present exemplary embodiment is used;

FIG. 4 is a diagram for describing an exemplary data structure of a gathering information table;

FIG. 5 is a diagram for describing an exemplary data structure of a mount-information table;

FIG. 6 is a diagram for describing an exemplary data structure of a sticky-note information table;

FIG. 7 is a diagram for describing an exemplary data structure of an explanatory-note area management table;

FIG. 8 is a diagram for describing an exemplary data structure of an explanatory-sticky-note management table;

FIG. 9 is a flowchart of an exemplary process according to the present exemplary embodiment;

FIG. 10 is a flowchart of an exemplary process according to the present exemplary embodiment;

FIG. 11 is a diagram for describing an exemplary process according to the present exemplary embodiment;

FIG. 12 is a diagram for describing an exemplary process according to the present exemplary embodiment;

FIG. 13 is a diagram for describing an exemplary process according to the present exemplary embodiment;

FIG. 14 is a diagram for describing an exemplary process according to the present exemplary embodiment;

FIG. 15 is a diagram for describing an exemplary process according to the present exemplary embodiment;

FIG. 16 is a diagram for describing an exemplary process according to the present exemplary embodiment;

FIG. 17 is a diagram for describing an exemplary process according to the present exemplary embodiment;

FIG. 18 is a diagram for describing an exemplary process according to the present exemplary embodiment;

FIG. 19 is a flowchart of an exemplary process according to the present exemplary embodiment; and

FIG. 20 is a block diagram illustrating an exemplary hardware configuration of a computer for implementing the present exemplary embodiment.

### DETAILED DESCRIPTION

A suitable exemplary embodiment for implementing the present disclosure will be described below on the basis of the drawings.

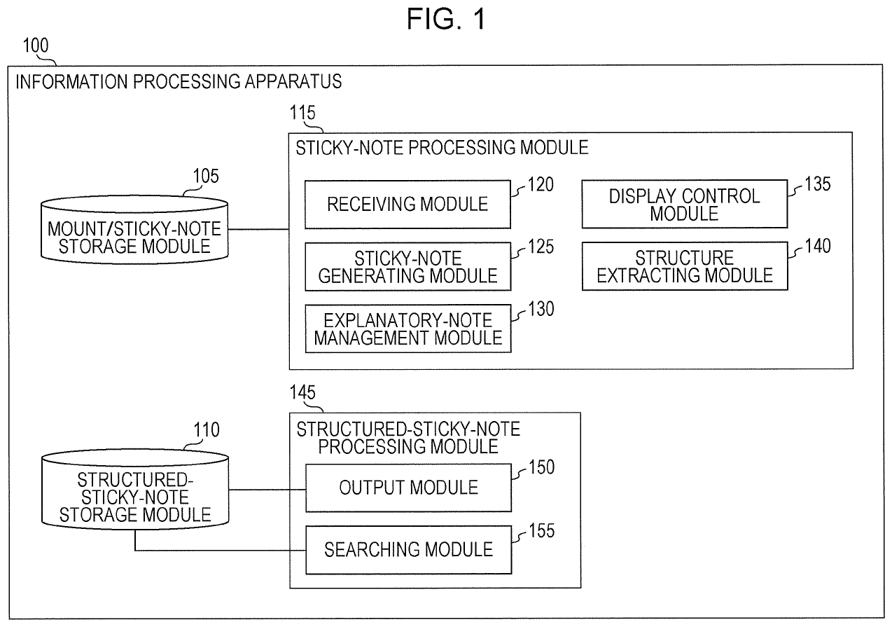

FIG. 1 is a schematic diagram illustrating an exemplary module configuration of the present exemplary embodiment.

In general, a module refers to a component, such as software (including a computer program as an interpretation of “software”), which is logically separable, or hardware. Thus, a module in the exemplary embodiment refers to not only a module in terms of a computer program but also a module in terms of a hardware configuration. Consequently, the exemplary embodiment also describes a system, a method, and a computer program for functioning as a module (for example, a program that causes a computer to execute procedures, a program that causes a computer to function as units, or a program that causes a computer to implement functions). For convenience of explanation, the terms “to store something” and “to cause something to store something”, and their equivalent terms are used. When the exemplary embodiment is implemented by using computer programs, these terms mean that a storage device stores something or that a storage device is controlled so as to store something. One module may correspond to one function. However, in the implementation, one program may constitute one module, or one program may constitute multiple modules. In contrast, multiple programs may constitute a single module. Additionally, multiple modules may be executed by a single computer, or one module may be executed by multiple computers in a distributed or parallel processing environment. One module may include another module. Hereinafter, the term “connect” refers to logical connection, such as transmission/reception of data, an instruction, reference relationship between pieces of data, or login, as well as physical connection. The term “predetermined” refers to a state in which determination has been made before a target process. This term also includes a meaning in which determination has been made in accordance with the situation or state at that time or the situation or state before that time, not only before processes according to the exemplary embodiment start, but also before the target process starts even after the processes according to the exemplary embodiment have started. When multiple “predetermined values” are present, these may be different from one another, or two or more of the values (the two or more of the values include all values, of course) may be the same. A description of “when A is satisfied, B is performed” is used as having a meaning of “Whether or not A is satisfied is determined and, when it is determined that A is satisfied, B is performed.” However, this term does not include the case where the determination as to whether or not A is satisfied is unnecessary. In addition, the case in which things are listed, such as “A, B, and C”, indicates exemplary listing unless otherwise noted, and includes the case in which only one member is selected (for example, only A).

A system or apparatus refers to one in which multiple computers, pieces of hardware, devices, and the like are connected to one another by using a communication unit such as a network (the “network” includes one-to-one communication connection), and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (that is, a social system) operating on man-made agreements.

For each of the processes performed by the respective modules, or for each of the processes if the processes are performed in a single module, target information is read out from a storage device. After the process is performed, the processing result is written in a storage device. Accordingly, description about the reading of data from the storage device before the process and the writing into the storage device after the process may be skipped. Examples of the storage device may include a hard disk drive, a random access memory (RAM), an external storage medium, a storage apparatus via a communication line, and a register in a central processing unit (CPU).

An information processing apparatus 100 according to the present exemplary embodiment has a function of displaying first information and a function of displaying second information illustrating the attributes of the first information. As illustrated in the example in FIG. 1, the information processing apparatus 100 includes a mount/sticky-note storage module 105, a structured-sticky-note storage module 110, a sticky-note processing module 115, and a structured-sticky-note processing module 145.

The first information, which is information displayed on a screen, is operated by a user. For example, the first information indicates sticky notes (sticky notes are also called, for example, electronic sticky notes or electronic cards), images, or the like. Hereinafter, when the first information is illustrated, sticky notes will be used in the description.

Similarly to the first information, the second information is information displayed on a screen, but illustrates the attributes of the first information. For example, the second information is information having a meaning as explanatory notes. For example, when the first information indicates sticky notes, the second information indicates explanatory sticky notes showing, for example, the meanings of sticky notes having certain attributes (or the content that is to be written in the sticky notes). This will be described by using a concrete example. An explanatory sticky note, which is pink and in which a word, “issue”, is written as its content, indicates that an issue is to be written as the content in a pink sticky note serving as the first information. The color and the content, which is to be written, of a sticky note is predetermined in such a manner that, for example, pink indicates an “issue”; yellow indicates a “reason”; blue indicates an “action”; green indicates a “result”. Such sticky notes are displayed on a mount as explanatory sticky notes. This facilitates grasping the meanings of sticky notes by using the colors in a gathering. As a matter of course, not only color but also an attribute of sticky notes may be used. In particular, an attribute about the display form is suitable as the attribute of sticky notes.

The information processing apparatus 100 specifically performs processes for a mount and sticky notes used in a gathering. Examples of the information processing apparatus 100 include systems called an electronic-sticky note control apparatus, an electronic-sticky note system, and an electronic whiteboard.

A gathering may indicate a talk among multiple persons. Examples of a gathering include a meeting, a workshop, an idea extraction meeting, a review meeting, a consultation, a discussion meeting, an assembly, and a session.

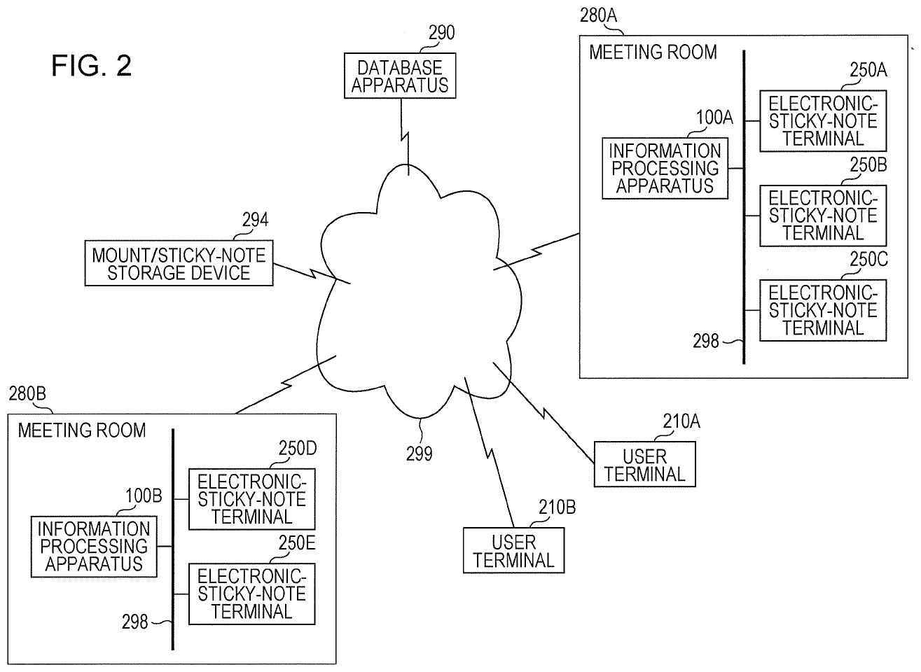

The information processing apparatus 100 is used specifically in a gathering held by facilitators (typically, one facilitator) and multiple participants by using sticky notes. The participants use electronic-sticky-note terminals 250, which serve as participant terminals, to create sticky notes on which idea and the like are written. Typically, as illustrated in the example in FIG. 2, there are multiple electronic-sticky-note terminals 250, such as an electronic-sticky-note terminal 250A and an electronic-sticky-note terminal 250B, which are carried by participants (hereinafter typically referred to as an electronic-sticky-note terminal 250). The information processing apparatus 100 receives sticky notes from the electronic-sticky-note terminal 250, and pastes the sticky notes on a mount (or a background). The facilitator uses a shared screen, which is a display apparatus of the information processing apparatus 100, to determine or change the positions of sticky notes on the mount, or to organize sticky notes (the expression “organize sticky notes” is also referred to as associating the sticky notes with each other, forming groups, or the like). The facilitator themselves, for example, creates sticky note information. Thus, the facilitator conducts the gathering. In the present exemplary embodiment, participants include a facilitator.

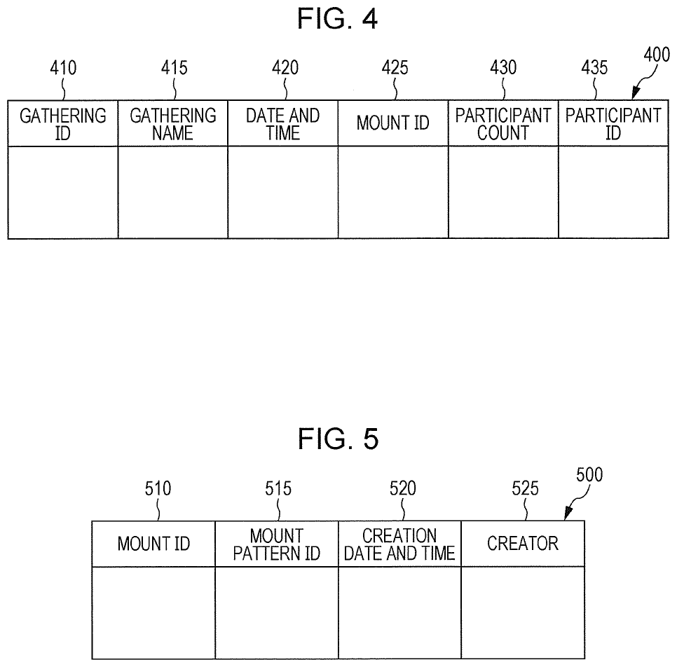

The mount/sticky-note storage module 105 is connected to the structured-sticky-note storage module 110. The mount/sticky-note storage module 105 stores information about a mount and sticky notes. Specifically, information described by using examples in FIGS. 4 to 8 is stored.

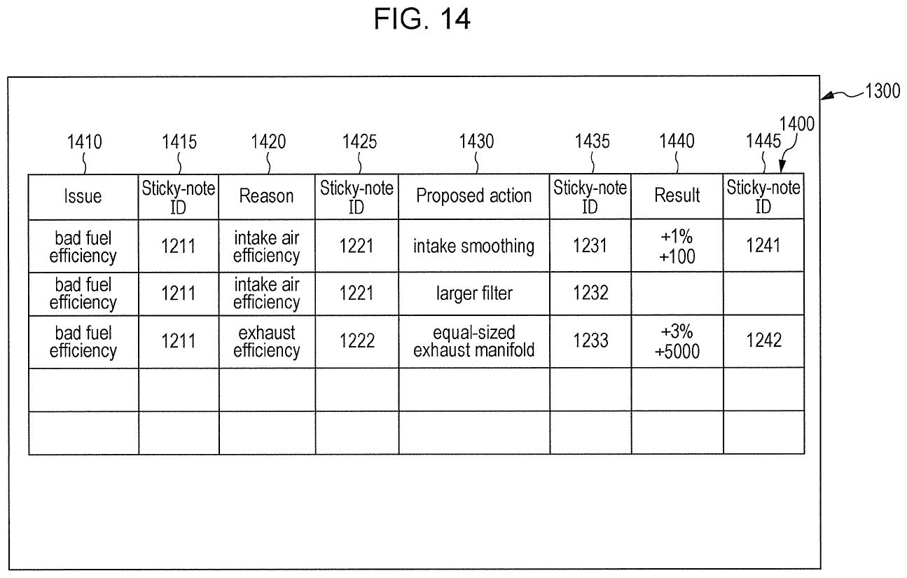

The structured-sticky-note storage module 110 is connected to an output module 150 and a searching module 155 of the structured-sticky-note processing module 145. The structured-sticky-note storage module 110 stores multiple sticky notes, which have a structure indicated by explanatory sticky notes, in such a manner that the structure is retained. The structure may be a link structure. As long as the structure is retained, a table structure or the like may be used. Specifically, a table and the like, which will be described below by using the example in FIG. 14, are stored.

The mount/sticky-note storage module 105 and the structured-sticky-note storage module 110 may be included in an apparatus other than the information processing apparatus 100. That is, the information processing apparatus 100 may use the mount/sticky-note storage module 105 and the structured-sticky-note storage module 110 through a communication line.

The sticky-note processing module 115 includes a receiving module 120, a sticky-note generating module 125, an explanatory-note management module 130, a display control module 135, and a structure extracting module 140. The sticky-note processing module 115 is connected to the mount/sticky-note storage module 105. For example, the sticky-note processing module 115 creates sticky notes, manages explanatory sticky notes, controls display of explanatory sticky notes and sticky notes, and extracts a structure formed by multiple sticky notes.

The receiving module 120 controls a liquid-crystal display serving also as a touch panel, and receives operations using a user's finger, a pen, or the like. In addition to this, the receiving module 120 may receive operations of a user using a mouse, a keyboard, a camera, a mike, and the like (including a sight of line, a gesture, and a voice). Alternatively or additionally, the receiving module 120 may perform communication (typically, wireless communication) with a portable communication device, which is carried by an operator, so as to receive operations on the portable communication device. Examples of received operations include creation, modification, deletion, moving, copying, and the like of a sticky note.

The sticky-note generating module 125 creates a sticky note according to operations received by the receiving module 120.

The explanatory-note management module 130 manages explanatory sticky notes. For example, the explanatory-note management module 130 displays explanatory sticky notes on a mount, creates explanatory sticky notes according to operations received by the receiving module 120, changes the attributes of explanatory sticky notes, creates the structure of explanatory sticky notes, and changes the structure.

The display control module 135 controls display of first information disposed on a screen and display of second information illustrating the attributes of the first information.

A mount may be displayed on a screen. The first information corresponds to, for example, sticky notes referred to also as electronic sticky notes. The second information corresponds to, for example, explanatory sticky notes and the like. In this example, sticky notes and explanatory sticky notes are displayed so as to be pasted on a mount.

The structure extracting module 140 extracts, by using the attributes and the structure of the second information, pieces of first information having attributes and a structure which are similar to those of the second information. Specifically, the structure extracting module 140 extracts the attributes of the second information and the connection relationship in the second information, and extracts a structure formed by using the second information. The structure extracting module 140 extracts pieces of second information having the same attributes as those of the first information, determines whether or not the extracted structure in the second information is the same structure as that in the first information, and regards the pieces of second information, which have the same structure, as an output target.

The structured-sticky-note processing module 145 includes an output module 150 and a searching module 155. The structured-sticky-note processing module 145 outputs pieces of first information forming a structure similar to that in the second information, and performs processes such as searching the output information by using the structure.

The output module 150 is connected to the structured-sticky-note storage module 110. In accordance with the structure in second information, the output module 150 outputs pieces of first information which have attributes matching those of the second information and which form the structure. The structure in first information may fully or partially match the structure in second information. An example of a partial match corresponds to, for example, the case in which, when the structure in second information is a link relationship indicating four pieces of information liked in series, the structure in first information is a link relationship indicating three pieces of information linked in series.

The expression “the structure in second information” indicates a structure formed by pieces of second information, and, for example, corresponds to a tree structure, a network structure, or the like. A piece of second information itself serves as a node of the structure, and a line connecting pieces of second information to each other serves as an edge.

The output module 150 outputs the result to the structured-sticky-note storage module 110.

The structured-sticky-note storage module 110 stores pieces of first information as structured information so as to be searchable.

Display form attributes of second information and the content attribute indicating the content written in the second information may be included as attributes of the second information.

When a display form attribute of first information matches a display form attribute of second information, the content written in the first information may be regarded as having the content attribute of the second information.

The output module 150 may output information in such a manner that the content attribute of first information is used as an item and the content, written in the first information, is used as the corresponding content.

The “display form attributes” include the shape, the pattern, and the color of a sticky note. Description will be made below by using color as an example. For example, assume that the display form attribute of an explanatory sticky note indicates red, and the content attribute indicates an issue. In this case, when a sticky note created by a user has a display form attribute indicating red, the content A written in the sticky note is handled as an issue. Information indicating that an issue is described as the content A is output. Specifically, in a table data structure, the content A is inserted in the issue field.

When there is no piece of first information forming the structure in second information, the output module 150 may output information in such a manner that the content attribute of the corresponding second information is used as an item and the content corresponding to the item is blank. For example, the output module 150 may output the information in the structured-sticky-note storage module 110.

When the field, in which the content for the item stored in the structured-sticky-note storage module 110 has been blank, is filled in, the display control module 135 may newly display, on the screen, the piece of first information including the written content.

The searching module 155 is connected to the structured-sticky-note storage module 110. The searching module 155 searches information, which is stored in the structured-sticky-note storage module 110, by using a structure in the information. The receiving module 120 may receive, as an operation from a user, specification of a search expression and an instruction for searching.

When a user has created first information, the searching module 155 may search the structured-sticky-note storage module 110 for information having a structure including characters and attributes in the first information.

The display control module 135 may display information, which is obtained through the searching by the searching module 155, near the first information created by the user.

FIG. 2 is a diagram for describing an exemplary system configuration using the present exemplary embodiment. Typically, the information processing apparatus 100 includes a display apparatus which has a large screen and which is operated by a facilitator. The display apparatus is controlled by the display control module 135, and may be viewed by all of the participants. The electronic-sticky-note terminals 250 are operated by the respective participants in a gathering. One electronic-sticky-note terminal 250 is typically carried by one participant. For example, tablet terminals or the like are used as the electronic-sticky-note terminals 250.

In the example in FIG. 2, in a meeting room 280A, an information processing apparatus 100A, an electronic-sticky-note terminal 250A, an electronic-sticky-note terminal 250B, and an electronic-sticky-note terminal 250C are disposed, and a gathering is conducted. The information processing apparatus 100A, the electronic-sticky-note terminal 250A, the electronic-sticky-note terminal 250B, and the electronic-sticky-note terminal 250C are connected to each other through a communication line 298. The communication line 298 may be wireless or wired, or may be a combination of these. For example, the communication line 298 may be the Internet, an intranet, or the like as a communication infrastructure.

In a meeting room 280B, an information processing apparatus 100B, an electronic-sticky-note terminal 250D, and an electronic-sticky-note terminal 250E are disposed, and a gathering different from that in the meeting room 280A is conducted. The information processing apparatus 100B, the electronic-sticky-note terminal 250D, and the electronic-sticky-note terminal 250E are connected to each other through the communication line 298.

A user terminal 210A, a user terminal 210B, a database apparatus 290, a mount/sticky-note storage device 294, the devices in the meeting room 280A, and the devices in the meeting room 280B are connected to each other through a communication line 299. The communication line 299 may be wireless or wired, or may be a combination of these. For example, the communication line 299 may be the Internet, an intranet, or the like as a communication infrastructure. The functions of the database apparatus 290 and the mount/sticky-note storage device 294 may be implemented as cloud services.

The database apparatus 290 communicates with the information processing apparatuses 100. The database apparatus 290 includes the structured-sticky-note storage module 110. That is, the information processing apparatuses 100 may use the structured-sticky-note storage module 110 in the database apparatus 290 through the communication line 299.

The mount/sticky-note storage device 294 stores information about a mount and sticky notes. Each information processing apparatus 100 may perform processes by using the mount/sticky-note storage device 294 instead of the mount/sticky-note storage module 105. In this case, information about a mount and sticky notes in the mount/sticky-note storage device 294 may be shared among the multiple information processing apparatuses 100. That is, information about a mount and sticky notes which is managed by the information processing apparatus 100A may be used by the information processing apparatus 100B.

The user terminals 210 are used by participants in the gatherings, and may access structured information in the database apparatus 290.

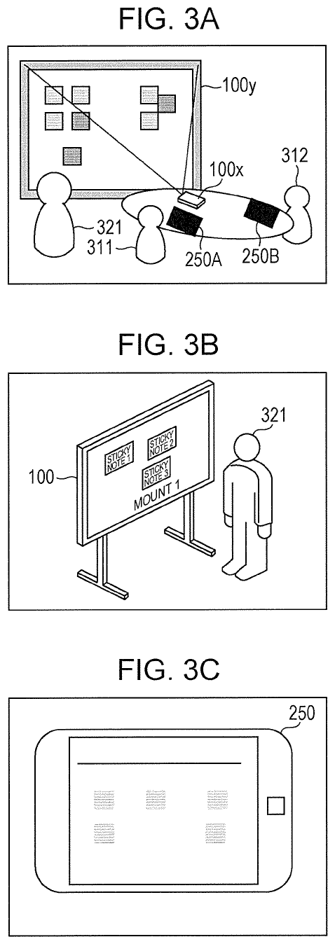

FIGS. 3A to 3C are diagrams for describing an example of use of the electronic-sticky-note terminals 250 and the information processing apparatus 100 in a meeting room 280 or the like in which the present exemplary embodiment is used.

As illustrated in the example in FIG. 3A, participants 311 and 312 and a facilitator 321 are gathering in a meeting room or the like. The participant 311 uses the electronic-sticky-note terminal 250A; the participant 312 uses the electronic-sticky-note terminal 250B. Typically, one electronic-sticky-note terminal 250 is given to one participant. As illustrated in the example in FIG. 3C, an electronic-sticky-note terminal 250 is a tablet terminal having substantially a note size (for example, the A4 size, the B5 size, or 7 to 10 inches), and is operated, for example, by using a finger or a pen. Participants create sticky note information describing text data, handwritten characters, figures, and the like. The terminal apparatus is not limited to a tablet terminal, and may be, for example, a personal computer (PC) which includes a notebook PC and which is provided with a keyboard, a mouse, and the like.

An information processing apparatus 100x illustrated in the example in FIG. 3A is a projector, and displays a mount and sticky notes. An information processing apparatus 100y, which is an electronic whiteboard, detects a move of the facilitator 321's finger, a pen, or the like, and receives operations, such as pasting a sticky note on a mount, moving a sticky note, and grouping sticky notes. For example, the information processing apparatus 100y, which is provided with a pen, detects the pen leaving the predetermined pen holder (specifically, the facilitator 321 picks up the pen for an operation) and the position of the tip of the pen (specifically, for example, the pen tip touches the information processing apparatus 100y). Thus, the information processing apparatus 100y receives an operation for the mount and the sticky notes. For example, a sensor (specifically, for example, a sensor in which the switch turns on/off by using the gravity of the pen) is provided for the pen holder. Among multiple pens (specifically, for example, a black pen, a red pen, and a blue pen), which pen is being used may be detected. The entire display screen of the information processing apparatus 100y may be formed of a touch sensor, and the position, at which the display screen is touched, and the pressure may be detected. In the example, the pen holder controls the on/off state of the pen. However, a pen holder is not necessarily provided. The on/off state may be controlled directly on the pen. To change the color, it is not necessary to provide a pen holder. A color palette may be prepared in a portion of the display screen. A function (specifically, for example, a button or a slider for performing the function) for changing the color or instructing a pen to change the color by touching a target color with a finger, a pen, or the like may be provided.

The information processing apparatus 100 may be an electronic board as illustrated in the example in FIG. 3B. An electronic board typically includes a display apparatus having a large screen (at least, larger than the display apparatus of an electronic-sticky-note terminal 250). The display apparatus is formed of a touch panel. The position, at which the display screen is touched, and the pressure are detected. For example, a screen having a size of 80 inches or the like may be provided.

FIG. 4 is a diagram for describing an exemplary data structure of a gathering information table 400. The gathering information table 400 is stored in the mount/sticky-note storage module 105. The gathering information table 400 includes a gathering ID field 410, a gathering name field 415, a date and time field 420, a mount ID field 425, a participant count field 430, and a participant ID field 435. The gathering ID field 410 stores information (specifically, the gathering identification (ID)) for identifying a gathering uniquely in the present exemplary embodiment. The gathering name field 415 stores the name of the gathering. The date and time field 420 stores the date and time (the date and time indicates year, month, day, hour, minute, second, and a decimal fraction of a second, or may be a combination of these) at which the gathering was conducted, or a period (the period indicates, for example, two dates and times, the start date and time and the end date and time, of the gathering). The mount ID field 425 stores information (specifically, the mount ID) for uniquely identifying the mount used in the gathering in the present exemplary embodiment. The participant count field 430 stores the number of participants in the gathering. The participant ID field 435 stores information (specifically, a list of participant IDs) for identifying the participants uniquely in the present exemplary embodiment.

FIG. 5 is a diagram for describing an exemplary data structure of a mount-information table 500. The mount-information table 500 is stored in the mount/sticky-note storage module 105. The mount-information table 500 includes a mount ID field 510, a mount pattern ID field 515, a creation date and time field 520, and a creator field 525. The mount ID field 510 stores the mount ID. The mount pattern ID field 515 stores the ID of a mount pattern serving as a background. For example, there are a white-paper pattern and a table-format pattern. As described below, the mount pattern may be such that an explanatory-note area is drawn. In addition, the mount pattern may be such that predetermined sticky notes have been pasted in the explanatory-note area. The creation date and time field 520 stores the creation date and time of the mount. The creator field 525 stores the creator of the mount.

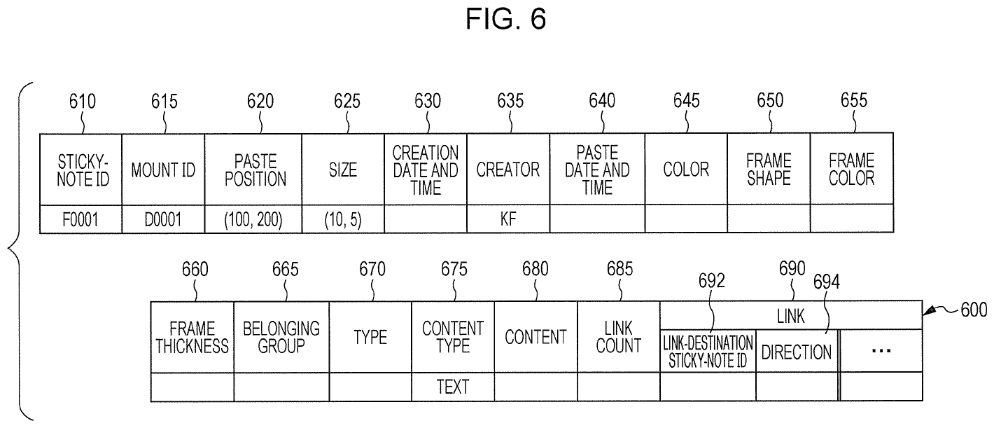

FIG. 6 is a diagram for describing an exemplary data structure of a sticky-note information table 600. The sticky-note information table 600 is stored in the mount/sticky-note storage module 105. The sticky-note information table 600 includes a sticky-note ID field 610, a mount ID field 615, a paste position field 620, a size field 625, a creation date and time field 630, a creator field 635, a paste date and time field 640, a color field 645, a frame shape field 650, a frame color field 655, a frame thickness field 660, a belonging group field 665, a type field 670, a content type field 675, a content field 680, a link count field 685, and a link field 690. The link field 690 includes link-destination sticky-note ID fields 692 and direction fields 694. The sticky-note ID field 610 stores the ID of a sticky note. The mount ID field 615 stores the ID of a mount on which the sticky note is pasted. The paste position field 620 stores the position at which the sticky note is pasted. That is, the paste position on the mount is stored. For example, it indicates the coordinates in the XY coordinates system on the mount (for example, the positions of the center and the top-left end of the sticky note). The size field 625 stores the size of the sticky note. For example, when a sticky note to be presented is rectangular, the width and the height are stored. The creation date and time field 630 stores the date and time at which the sticky note was created. The creator field 635 stores the creator of the sticky note. Alternatively, the information processing apparatus (for example, the device ID of the electronic-sticky-note terminal 250 or the information processing apparatus 100) which created the sticky note may be stored. The paste date and time field 640 stores the date and time at which the sticky note was pasted on the mount. The color field 645 stores the display color of the sticky note. The frame shape field 650 stores the shape (for example, a solid line, a dotted line, a dashed line, a wavy line, or a double line) of the frame used in display of the sticky note. The frame color field 655 stores the color of the frame used in display of the sticky note. The frame thickness field 660 stores the thickness of the frame in display of the sticky note. The belonging group field 665 stores information about a group to which the sticky note belongs. For example, information indicating whether or not the sticky note belongs to a group may be stored. When the sticky note belongs to a group, for example, the group ID and the other sticky note IDs belonging to the group may be stored. The type field 670 stores the type of the sticky note. Specifically, there are a first sticky note, which is a general-purpose sticky note, and a second sticky note which is an explanatory sticky note. The content type field 675 stores the content type of the sticky note (for example, vector data indicating text information, handwritten characters, figures, and the like, voice information, still image information such as a photograph, moving image information, or information indicating a combination of these). The content field 680 stores the content written in the sticky note. The link count field 685 stores the number of links. The link field 690 stores the link-destination sticky-note ID fields 692 and the direction fields 694 which indicate information about links. Sets of a link-destination sticky-note ID field 692 and a direction field 694, whose number is equal to the number in the link count field 685, are continuously described in the link field 690. The link-destination sticky-note ID field 692 stores the sticky note ID of a sticky note connected to the sticky note in the sticky-note ID field 610. The direction field 694 stores the direction of the link connecting the sticky note in the sticky-note ID field 610 to the sticky note in the link-destination sticky-note ID field 692. For example, the direction field 694 may store the link direction from the sticky note in the sticky-note ID field 610 to the sticky note in the link-destination sticky-note ID field 692. Alternatively, the direction field 694 may store the link direction from the sticky note in the link-destination sticky-note ID field 692 to the sticky note in the sticky-note ID field 610. Alternatively, the direction field 694 may store the two-way link direction between the sticky note in the sticky-note ID field 610 and the sticky note in the link-destination sticky-note ID field 692. Alternatively, no link directions may be stored.

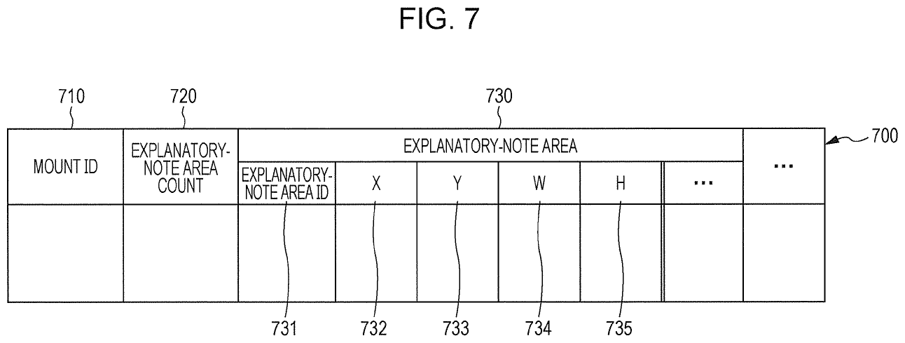

FIG. 7 is a diagram for describing an exemplary data structure of an explanatory-note area management table 700.

The explanatory-note area management table 700 includes a mount ID field 710, an explanatory-note area count field 720, and an explanatory-note area field 730. The explanatory-note area field 730 includes explanatory-note area ID fields 731, X fields 732, Y fields 733, W fields 734, and H field 735s. The explanatory-note area management table 700 is stored in the mount/sticky-note storage module 105. The mount ID field 710 stores a mount ID. The explanatory-note area count field 720 stores the number of explanatory-note areas drawn on the mount. The explanatory-note area field 730 stores the explanatory-note area ID fields 731, the X fields 732, the Y fields 733, the W fields 734, and the H fields 735 which indicate explanatory note areas. The explanatory-note area field 730 includes the field sets from an explanatory-note area ID field 731 to an H field 735, whose number is equal to the explanatory-note area count in the explanatory-note area count field 720. In the present exemplary embodiment, the explanatory-note area ID field 731 stores information (specifically, the explanatory-note area ID) for identifying an explanatory-note area uniquely. The X field 732 stores, for example, the X coordinate of the upper left corner of the explanatory-note area. The Y field 733 stores, for example, the Y coordinate of the upper left corner of the explanatory-note area. The W field 734 stores W (“W” indicates the width of an area) of the explanatory-note area. The H field 735 stores H (“H” indicates the height of an area) of the explanatory-note area.

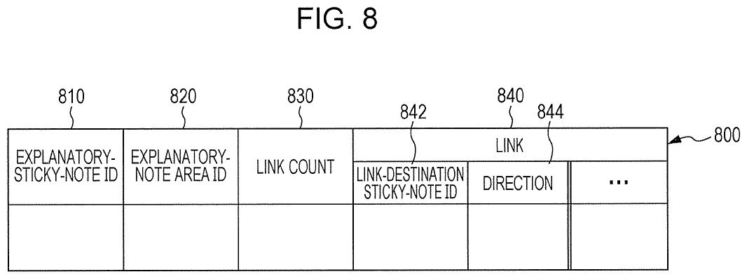

FIG. 8 is a diagram for describing an exemplary data structure of an explanatory-sticky-note management table 800.

The explanatory-sticky-note management table 800 includes an explanatory-sticky-note ID field 810, an explanatory-note area ID field 820, a link count field 830, and a link field 840. The link field 840 includes link-destination sticky-note ID fields 842 and direction fields 844. The explanatory-sticky-note management table 800 is stored in the mount/sticky-note storage module 105. In the present exemplary embodiment, the explanatory-sticky-note ID field 810 stores information (specifically, the explanatory sticky note ID) for identifying an explanatory sticky note uniquely. The explanatory-note area ID field 820 stores the explanatory-note area ID of the explanatory-note area in which the explanatory sticky note is pasted. The link count field 830 stores the number of links of the explanatory sticky note. The link field 840 stores the link-destination sticky-note ID fields 842 and the direction fields 844 which indicate information about links. The link field 840 has continuous sets of a link-destination sticky-note ID field 842 and a direction field 844, whose number is equal to the value in the link count field 830. Similarly to a link-destination sticky-note ID field 692 of the sticky-note information table 600, the link-destination sticky-note ID field 842 stores the explanatory sticky note ID of an explanatory sticky note connected to the sticky note in the explanatory-sticky-note ID field 810. Similarly to a direction field 694 of the sticky-note information table 600, the direction field 844 stores the direction of the link.

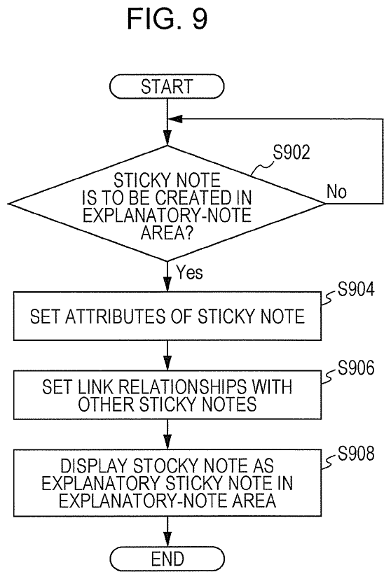

FIG. 9 is a flowchart of an exemplary process according to the present exemplary embodiment. Before start of the discussion in a gathering, explanatory sticky notes are created according to operations of a user. Alternatively, predetermined explanatory notes may be used.

In step S902, it is determined whether or not a sticky note is to be created in an explanatory-note area. If a sticky note is to be created, the process proceeds to step S904. Otherwise, the process waits until it is determined that a sticky note is to be created.

In step S904, the attributes of the sticky note are set. For example, the color field 645, the frame shape field 650, the frame color field 655, and the frame thickness field 660 which describe the display form attributes of the sticky-note information table 600 are set in accordance with operations of a user. Since the sticky note is to be disposed in the explanatory-note area, the type is set as an explanatory sticky note in the type field 670.

In step S906, link relationships with other sticky notes are set. In accordance with operations of a user, the explanatory-sticky-note management table 800 is set. An example of the operations of a user corresponds to an operation of drawing a link from one explanatory sticky note to another explanatory sticky note. In this operation, a link having a direction from one explanatory sticky note to another explanatory sticky note is set.

In step S908, the sticky note is displayed in the explanatory-note area as an explanatory sticky note.

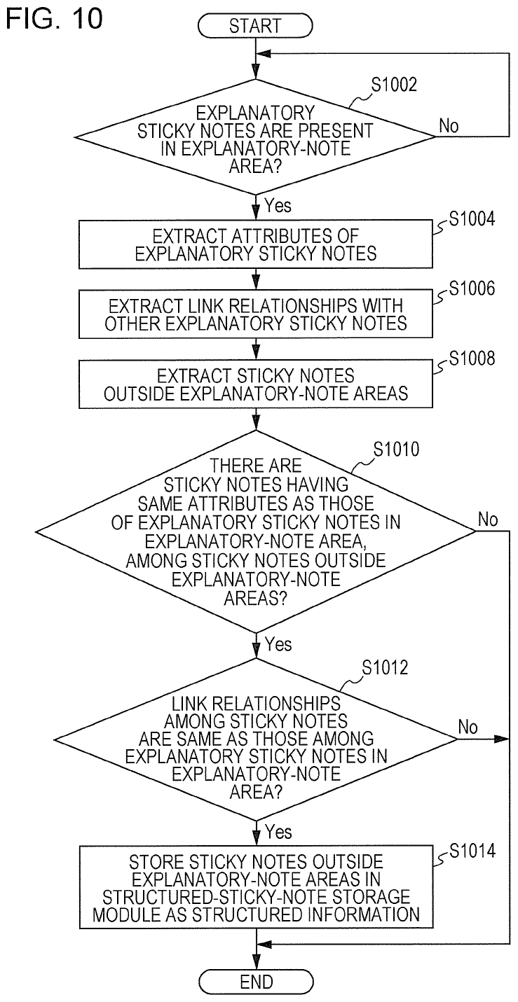

FIG. 10 is a flowchart of an exemplary process according to the present exemplary embodiment. FIG. 10 illustrates an exemplary process of extracting sticky notes, which have the same structure as that of explanatory sticky notes, from the sticky notes pasted on a mount.

In step S1002, it is determined whether or not explanatory sticky notes are present in an explanatory-note area. If explanatory sticky notes are present, the process proceeds to step S1004. Otherwise, the process waits until explanatory sticky notes appear.

In step S1004, the attributes of the explanatory sticky notes are extracted. Specifically, the explanatory-sticky-note management table 800 is used to extract the explanatory sticky notes pasted in the explanatory-note area. The sticky-note information table 600 is used to extract the attributes about the display form of the explanatory sticky notes.

In step S1006, the link relationships with other explanatory sticky notes are extracted. Specifically, the explanatory-sticky-note management table 800 is used to extracts the link relationships.

In step S1008, sticky notes outside the explanatory-note areas are extracted. That is, general-purpose sticky notes pasted on the mount are extracted.

In step S1010, it is determined whether or not there are sticky notes having the same attributes as those of the explanatory sticky notes in the explanatory-note area, among the sticky notes outside the explanatory-note areas. If there are such sticky notes, the process proceeds to step S1012. Otherwise, the process ends. It is determined whether or not there are general-purpose sticky notes having the same attributes as those extracted in step S1004.

In step S1012, if it is determined whether or not the link relationships among the sticky notes are the same as those among the explanatory sticky notes in the explanatory-note area. If the determination result is positive, the process proceeds to step S1014. Otherwise, the process ends. It is determined whether or not the link relationships among the general-purpose sticky notes having the same attributes as those of explanatory sticky notes are the same as those among the explanatory sticky notes.

In step S1014, the sticky notes outside the explanatory-note areas are stored in the structured-sticky-note storage module 110 as structured information.

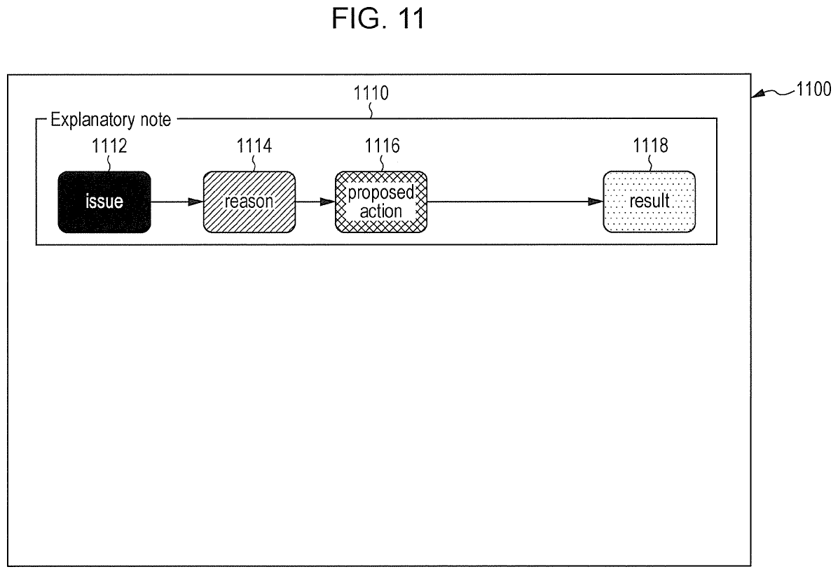

FIG. 11 is a diagram for describing an exemplary process according to the present exemplary embodiment.

For example, on a mount 1100, an explanatory-note area 1110 is displayed. An explanatory sticky note 1112, an explanatory sticky note 1114, an explanatory sticky note 1116, and an explanatory sticky note 1118 are displayed in the explanatory-note area 1110.

The explanatory sticky note 1112 is a pink explanatory sticky note indicating an “issue”. The explanatory sticky note 1112 is linked to the explanatory sticky note 1114.

The explanatory sticky note 1114 is a yellow explanatory sticky note indicating a “reason”. The explanatory sticky note 1114 is linked to the explanatory sticky note 1116.

The explanatory sticky note 1116 is a blue explanatory sticky note indicating a “proposed action”. The explanatory sticky note 1116 is linked to the explanatory sticky note 1118.

The explanatory sticky note 1118 is a green explanatory sticky note indicating a “result”.

The link relationships of these indicate that the explanatory sticky note 1112 is connected to the explanatory sticky note 1114 in this direction; the explanatory sticky note 1114 is connected to the explanatory sticky note 1116 in this direction; the explanatory sticky note 1116 is connected to the explanatory sticky note 1118 in this direction. A participant in the gathering who is a user and who views the link relationships understands that an “issue” is to be written in a pink sticky note; a “reason” is to be written in a yellow sticky note; a “proposed action” is to be written in a blue sticky note; a “result” is to be written in a green sticky note. In addition, the participant in the gathering understands that an “issue” sticky note is to be connected to a sticky note describing a “reason” of the issue by using a line; the “reason” sticky note is to be connected to a sticky note describing a “proposed action” for the reason by using a line; the “proposed action” sticky note is to be connected to a sticky note describing a “result” describing the implementation result of the proposed action by using a line.

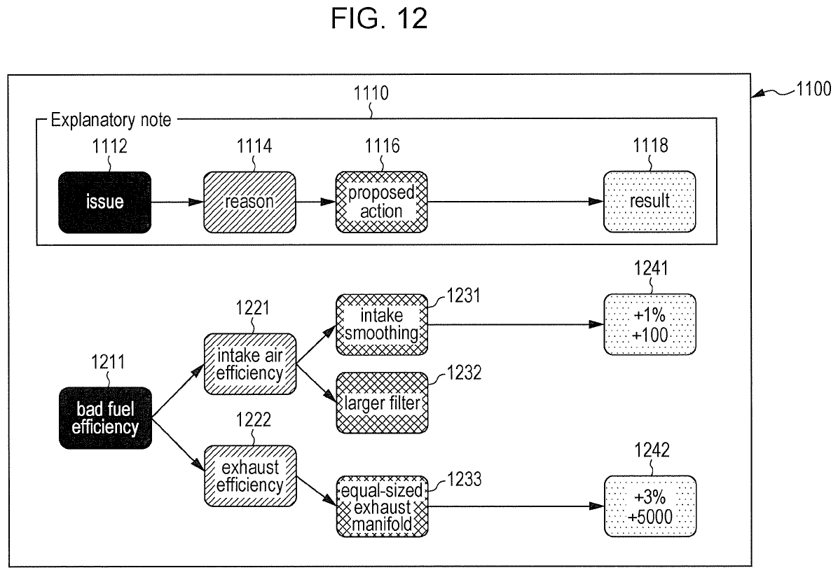

FIG. 12 is a diagram for describing an exemplary process according to the present exemplary embodiment.

As a result of a discussion in the gathering using the mount 1100 illustrated in the example in FIG. 11, on the mount 1100, a sticky note 1211, a sticky note 1221, a sticky note 1222, a sticky note 1231, a sticky note 1232, a sticky note 1233, a sticky note 1241, and a sticky note 1242 are created and pasted in addition to the explanatory-note area 1110.

The sticky note 1211 is a pink sticky note, that is, a sticky note indicating an issue, on which “bad fuel efficiency” is written. The sticky note 1211 is linked to the sticky note 1221 and the sticky note 1222.

The sticky note 1221 is a yellow sticky note, that is, a sticky note indicating a reason, on which “intake air efficiency” is written. The sticky note 1221 is linked to the sticky note 1231 and the sticky note 1232.

The sticky note 1222 is a yellow sticky note, that is, a sticky note indicating a reason, on which “exhaust efficiency” is written. The sticky note 1222 is linked to the sticky note 1233.

The sticky note 1231 is a blue sticky note, that is, a sticky note indicating a proposed action, on which “intake smoothing” is written. The sticky note 1231 is linked to the sticky note 1241.

The sticky note 1232 is a blue sticky note, that is, a sticky note indicating a proposed action, on which “larger filter” is written.

The sticky note 1233 is a blue sticky note, that is, a sticky note indicating a proposed action, on which “equal-sized exhaust manifold” is written. The sticky note 1233 is linked to the sticky note 1242.

The sticky note 1241 is a green sticky note, that is, a sticky note indicating a result, on which “+1%, +100” is written.

The sticky note 1242 is a green sticky note, that is, a sticky note indicating a result, on which “+3%, +5000” is written.

The link relationship between the sticky note 1211, the sticky note 1221, the sticky note 1231, and the sticky note 1241 matches the structure of the explanatory sticky notes in the explanatory-note area 1110. The link relationship between the sticky note 1211, the sticky note 1221, and the sticky note 1232 matches the structure of explanatory sticky notes in the explanatory-note area 1110. This match indicates a partial match. The link relationship between the sticky note 1211, the sticky note 1222, the sticky note 1233, and the sticky note 1242 matches the structure of explanatory sticky notes in the explanatory-note area 1110.

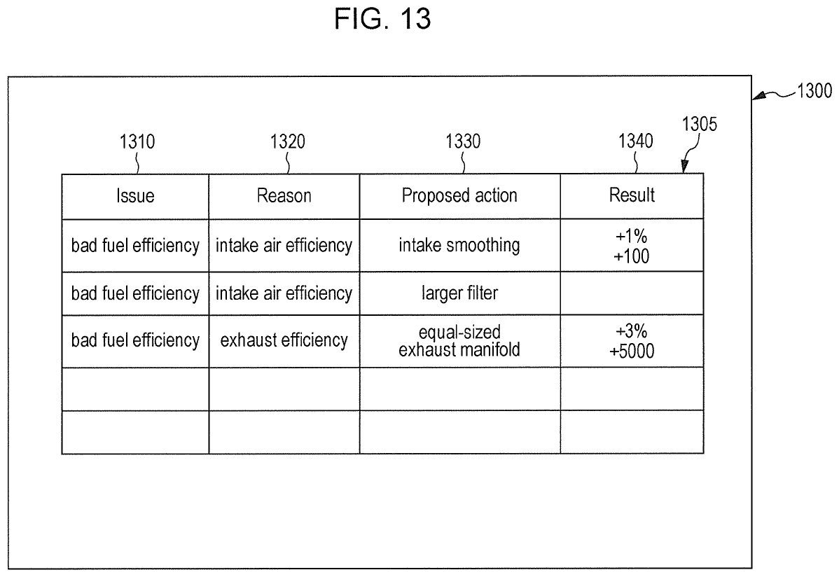

FIG. 13 is a diagram for describing an exemplary process according to the present exemplary embodiment. FIG. 13 illustrates exemplary information in the structured-sticky-note storage module 110 which is obtained when the sticky notes illustrated in the example in FIG. 12 are subjected to the process according to the example in FIG. 10. A screen 1300 may be the same screen as that on which the mount 1100 is displayed. Alternatively, the screen 1300 may be a screen on which information (that is, the same information as that in the structured-sticky-note storage module 110) in the database apparatus 290 is displayed by using a user terminal 210 or the like.

For example, an issue management table 1305 is displayed on the screen 1300.

The issue management table 1305 includes an issue field 1310, a reason field 1320, a proposed action field 1330, and a result field 1340. The issue field 1310 stores an issue; the reason field 1320 stores a reason; the proposed action field 1330 stores a proposed action; the result field 1340 stores a result. That is, the issue management table 1305 indicates the structures of the general-purpose sticky notes illustrated in the example in FIG. 12. The columns are arranged on the basis of the display form attribute, and the rows are arranged on basis of the connection relationships between the sticky notes.

Specifically, the first row of the issue management table 1305 is created from the explanatory sticky notes. In the first row of the issue management table 1305, “issue” in the explanatory sticky note 1112, which is a pink sticky note, is written in the issue field 1310; “reason” in the explanatory sticky note 1114, which is a yellow sticky note, is written in the reason field 1320; “proposed action” in the explanatory sticky note 1116, which is a blue sticky note, is written in the proposed action field 1330; “result” in the explanatory sticky note 1118, which is a green sticky note, is written in the result field 1340.

The second row and its subsequent rows of the issue management table 1305 are created from the general-purpose sticky notes having the same structure as that of the explanatory sticky notes. The issue field 1310 in the second row of the issue management table 1305 describes the content of the sticky note 1211; the reason field 1320 describes the content of the sticky note 1221; the proposed action field 1330 describes the content of the sticky note 1231; the result field 1340 describes the content of the sticky note 1241. The issue field 1310 in the third row describes the content of the sticky note 1211; the reason field 1320 describes the content of the sticky note 1221; the proposed action field 1330 describes the content of the sticky note 1232; the result field 1340 describes a blank since there is no corresponding sticky note. The issue field 1310 in the fourth row describes the content of the sticky note 1211; the reason field 1320 describes the content of the sticky note 1222: the proposed action field 1330 describes the content of the sticky note 1233; the result field 1340 describes the content of the sticky note 1242.

FIG. 14 is a diagram for describing an exemplary process according to the present exemplary embodiment. FIG. 14 illustrates the issue management table 1305, which is illustrated in the example in FIG. 13, plus information about the original sticky tab IDs.

For example, an issue/sticky-note management table 1400 is displayed on the screen 1300.

The issue/sticky-note management table 1400 includes an issue field 1410, a sticky-note ID field 1415, a reason field 1420, a sticky-note ID field 1425, a proposed action field 1430, a sticky-note ID field 1435, a result field 1440, and a sticky-note ID field 1445. The issue field 1410 stores an issue. The sticky-note ID field 1415 stores the sticky note ID of the original sticky note for the issue field 1410. The reason field 1420 stores a reason. The sticky-note ID field 1425 stores the sticky note ID of the original sticky note for the reason field 1420. The proposed action field 1430 stores a proposed action. The sticky-note ID field 1435 stores the sticky note ID of the original sticky note for the proposed action field 1430. The result field 1440 stores a result. The sticky-note ID field 1445 stores the sticky note ID of the original sticky note for the result field 1440.

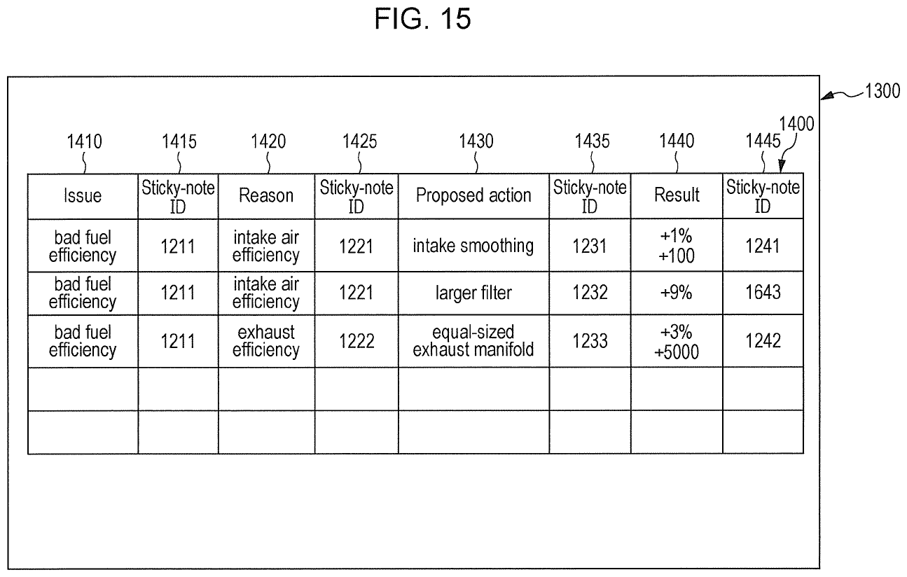

FIG. 15 is a diagram for describing an exemplary process according to the present exemplary embodiment. FIG. 15 illustrates a table in which the third-row field, which has been blank in the issue/sticky-note management table 1400 illustrated in the example in FIG. 14, of the result field 1440 is filled in according to operations of a user. In this example, “+9%” is written. Then, a general-purpose sticky note is created in accordance with the writing. In this example, the sticky note ID of the created sticky note is “1643”.

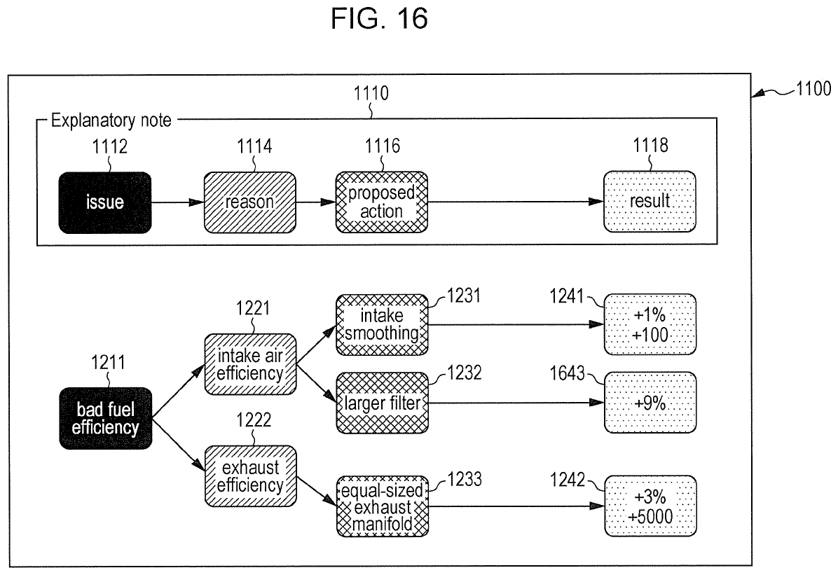

FIG. 16 is a diagram for describing an exemplary process according to the present exemplary embodiment. FIG. 16 illustrates an example in which a sticky note is added on the mount 1100 according to the issue/sticky-note management table 1400 illustrated in the example in FIG. 15.

One general-purpose sticky note, that is, a sticky note 1643, is added to the mount 1100 illustrated in the example in FIG. 12. The sticky note 1643 is green and indicates a result. On the sticky note 1643, “+9%” is written as the content. The sticky note 1643 is created, not through operations of a user on the mount, through an operation in which the third row of the result field 1440 in the issue/sticky-note management table 1400 illustrated in the example in FIG. 15 is filled in.

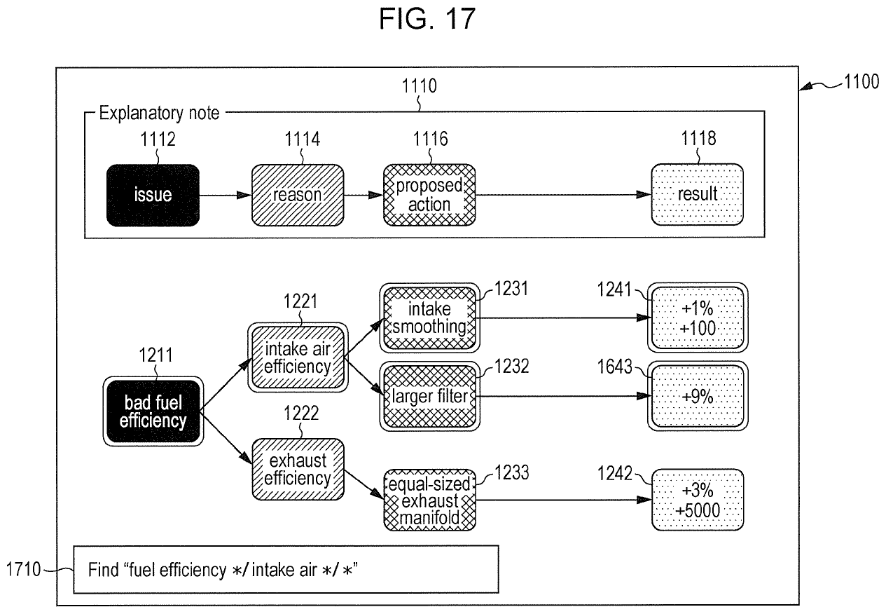

FIG. 17 is a diagram for describing an exemplary process according to the present exemplary embodiment.

FIG. 17 illustrates an example in which, in the state of the mount 1100 in the example in FIG. 16, a search using a structure is performed.

On the mount 1100, a search area 1710 is displayed, and a search expression is written through an operation of a user. In this example, an example in which ‘Find “fuel efficiency*/intake air*/*”’ is written in the search area 1710 is illustrated. The search expression indicates a search with a structure, and is used to search for “sticky notes having the following structure: there is a first sticky note that includes a string starting with ‘fuel efficiency’; there is a second sticky note that includes a string starting with ‘intake air’ and that is a link destination of the first sticky note; and the second sticky note is linked to zero or more sticky notes”.

As sticky notes corresponding to this search expression, sticky notes of the sticky note 1211, the sticky note 1221, the sticky note 1231, and the sticky note 1241, and sticky notes of the sticky note 1211, the sticky note 1221, the sticky note 1232, and the sticky note 1643 are extracted. A double frame is used as the display form of the sticky note 1211, the sticky note 1221, the sticky note 1231, the sticky note 1232, the sticky note 1241, and the sticky note 1643. That is, the search results are displayed by using the sticky notes on the mount. Specifically, the sticky notes on the mount are displayed so that the display form of sticky notes matching the search expression is different from that of the other sticky notes (that is, sticky notes which do not match the search expression).

The search expression may include, not only the structure and characters written as the content of sticky notes, but also attributes of sticky notes. That is, the search expression may include information indicating, for example, that the color of a sticky note is pink.

As the search expression, a general-purpose sticky note, which is created by a user, itself may be specified. In this case, the search target is general-purpose sticky notes having characters, written as the content, or the attributes of the specified general-purpose sticky note. In addition, the search target is general-purpose sticky notes having the same attributes and structure as those of explanatory sticky notes included in a structure including an explanatory sticky note having the same attribute as that of the specified general-purpose sticky note.

For example, in the case where the sticky note 1221 in FIG. 17 is specified for a search, not only is the sticky note 1221 used as a search target, but also general-purpose sticky notes, which have the structure including the explanatory sticky note 1114 corresponding to the sticky note 1221, that is, the structure formed by the explanatory sticky note 1112, the explanatory sticky note 1114, the explanatory sticky note 1116, and the explanatory sticky note 1118, are searched for. In this example, general-purpose sticky notes of the sticky note 1211, the sticky note 1221, the sticky note 1231, and the sticky note 1241, and general-purpose sticky notes of the sticky note 1211, the sticky note 1221, the sticky note 1232, and the sticky note 1643 are extracted as search results. Then the sticky note 1211, the sticky note 1231, the sticky note 1232, the sticky note 1241, and the sticky note 1643 are displayed near the sticky note 1221. In addition, a line connecting the sticky note 1211 to the sticky note 1221, a line connecting the sticky note 1221 to the sticky note 1231, a line connecting the sticky note 1221 to the sticky note 1232, a line connecting the sticky note 1231 to the sticky note 1241, and a line connecting the sticky note 1232 to the sticky note 1643 may be displayed in accordance with the link structure.

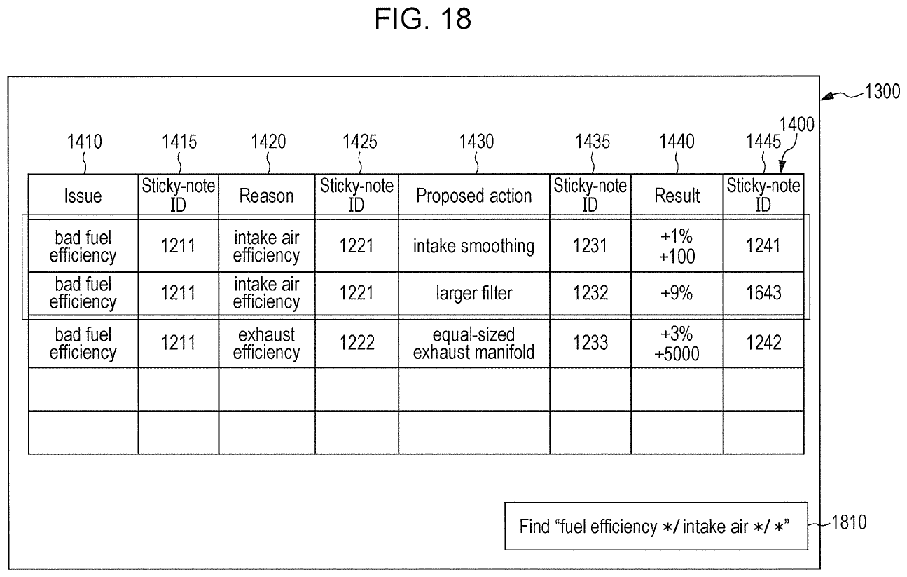

FIG. 18 is a diagram for describing an exemplary process according to the present exemplary embodiment.

Similarly to the example in FIG. 17, FIG. 18 illustrates an example of searching the issue/sticky-note management table 1400 in the example in FIG. 15 by using a structure.

On the screen 1300, a search area 1810 is displayed, and a search expression is written in accordance with an operation of a user. An example in which, like the example in FIG. 17, ‘Find “fuel efficiency*/intake air*/*”’ is written in the search area 1810 is illustrated.

As data matching the search expression, the second row and the third row of the issue/sticky-note management table 1400 are extracted. The display form is such that the second row and the third row are displayed by using double frames.

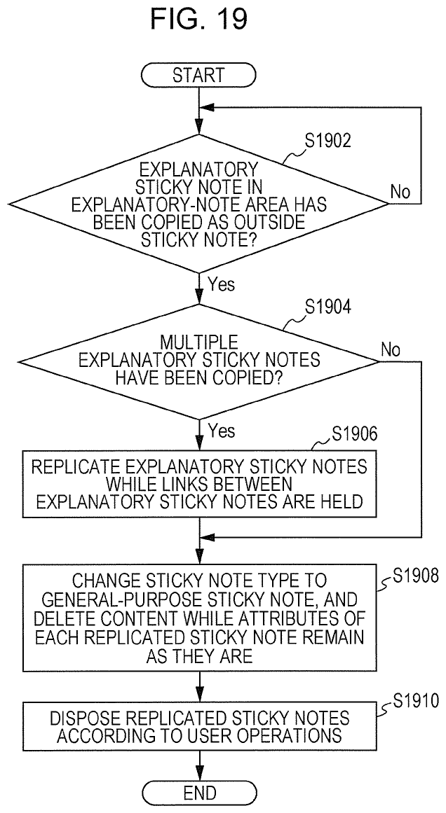

FIG. 19 is a flowchart of an exemplary process according to the present exemplary embodiment. FIG. 19 illustrates an example of copying an explanatory sticky note as a general-purpose sticky note for use.

In step S1902, it is determined whether or not an explanatory sticky note in an explanatory-note area has been copied as an outside sticky note. If an explanatory sticky note has been copied, the process proceeds to step S1904. Otherwise, the process waits until an explanatory sticky note is copied.

In step S1904, it is determined whether or not multiple explanatory sticky notes have been copied. If multiple explanatory sticky notes have been copied, the process proceeds to step S1906. Otherwise, the process proceeds to step S1908.

In step S1906, while the links between the explanatory sticky notes are held, the explanatory sticky notes are replicated.

In step S1908, while the attributes of each replicated sticky note remain as they are, the sticky note type is changed to the general-purpose sticky note, and its content is deleted. That is, a blank general-purpose sticky note whose display forms are the same as those of the explanatory sticky note is created.

In step S1910, each replicated sticky note is disposed according to an operation of a user.

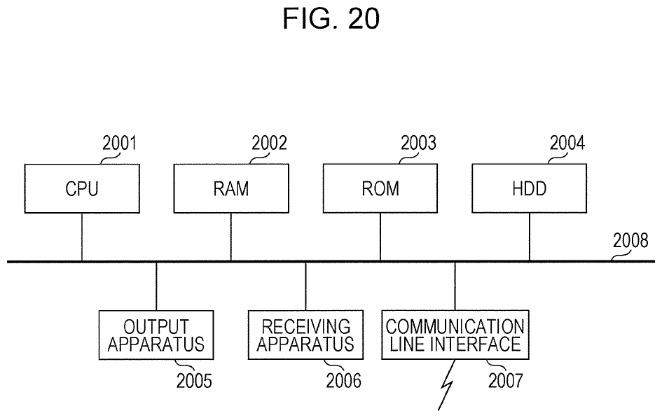

As illustrated in FIG. 20, the hardware configuration of a computer executing programs serving as the exemplary embodiment indicates a typical computer. Specifically, a computer or the like which may function as a personal computer or a server may be used. That is, as a concrete example, a CPU 2001 is used as a processor (arithmetic logical unit). A RAM 2002, a read-only memory (ROM) 2003, and a hard disk drive (HDD) 2004 are used as storage devices. As the HDD 2004, for example, an HDD and a solid state drive (SSD) which is a flash memory may be used. The computer includes the CPU 2001, the RAM 2002, the ROM 2003, the HDD 2004, a receiving apparatus 2006, an output apparatus 2005, a communication line interface 2007, and a bus 2008. The CPU 2001 executes programs, for example, for the sticky-note processing module 115, the receiving module 120, the sticky-note generating module 125, the explanatory-note management module 130, the display control module 135, the structure extracting module 140, the structured-sticky-note processing module 145, the output module 150, and the searching module 155. The RAM 2002 is used to store these programs and data. The ROM 2003 is used to store, for example, programs for starting the computer. The HDD 2004 is an auxiliary storage device which had the functions of the mount/sticky-note storage module 105 and the structured-sticky-note storage module 110, and the like. The receiving apparatus 2006 receives data on the basis of users' operations (including a motion, a voice, and the line of sight) on a keyboard, a mouse, a touch screen, a microphone, a camera (including a line-of-sight detecting camera or the like), and the like. Examples of the output apparatus 2005 include a cathode-ray tube (CRT), a liquid-crystal display, and a speaker. The communication line interface 2007 such as a network interface card is used to connect to a communication network. The bus 2008 is used to connect these units to one another for data transfer. Such computers may be connected to one another over a network.

For an exemplary embodiment which is achieved by using computer programs and which serves as the above-described exemplary embodiment, the computer programs which are software are read into a system having the hardware configuration, and the software and hardware resources cooperate with each other to achieve the above-described exemplary embodiment.

The hardware configuration in FIG. 20 is merely one exemplary configuration. The exemplary embodiment is not limited to the configuration in FIG. 20, and may have any configuration as long as the modules described in the exemplary embodiment may be executed. For example, a subset of the modules may be formed of dedicated hardware, such as an application specific integrated circuit (ASIC) or a field-programmable gate array (FPGA), and a subset of the modules may be installed in an external system connected through a communication line. In addition, systems having the configuration illustrated in FIG. 20 may be connected to one another through communication lines and may cooperate with one another. In particular, the hardware configuration may be installed in portable information communication equipment (including a portable phone, a smartphone, a mobile device, and a wearable computer), home information equipment, a robot, a copier, a fax, a scanner, a printer, a multi-function device (an image processing device having at least two of the functions of scanning, printing, copying, faxing, and the like), or the like as well as a personal computer.

The programs described above may be provided through a recording medium storing the programs, or may be provided through a communication unit. In these cases, for example, the programs described above may be interpreted as a disclosure of “a computer-readable recording medium that stores a program”.

The term “a computer-readable recording medium that stores a program” refers to a computer-readable recording medium that stores programs and that is used for, for example, installation and execution of the programs and distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray™ Disk, a magneto-optical disk (MO), a flexible disk (FD), a magnetic tape, a hard disk, a ROM, an electrically erasable programmable ROM (EEPROM™), a flash memory, a RAM, and a secure digital (SD) memory card.

All or a subset of the above-described programs may be stored and distributed by recording them on the recording medium. In addition, the programs may be transmitted through communication, for example, by using a transmission medium of, for example, a wired network or a wireless communication network which is used for a local area network (LAN), a metropolitan area network (MAN), a wide area network (WAN), the Internet, an intranet, an extranet, and the like, or a combination of these. Alternatively, the programs may be carried on carrier waves.

The above-described programs may form a subset or all of other programs, or may be recorded on a recording medium along with other programs. Alternatively, the programs may be recorded on multiple recording media by dividing the programs. The programs may be recorded in any format, such as compression or encryption, as long as it is possible to restore the programs.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a display controller that controls display of first information disposed on a screen, and that controls display of second information illustrating an attribute of the first information; and
an output unit that outputs a plurality of pieces of first information in accordance with a structure in the second information, the plurality of pieces of first information matching the second information in terms of the attribute and forming the structure.

2. The information processing apparatus according to claim 1, further comprising:
a searching unit,
wherein the output unit outputs the plurality of pieces of first information to a storage unit,
wherein the storage unit stores the plurality of pieces of first information in such a manner that the plurality of pieces of first information are searchable as structured information, and
wherein the searching unit searches information stored in the storage unit, by using a structure in information.

3. The information processing apparatus according to claim 2,
wherein, when a user creates the first information, the searching unit searches the storage unit for information having a structure including a character in the first information and the attribute of the first information, and
wherein the display controller displays the information obtained through the search performed by the searching unit, near the first information created by the user.

4. The information processing apparatus according to claim 1,
wherein attributes of the second information include a display form attribute of the second information and a content attribute indicating content written in the second information,
wherein, when a display form attribute of the first information matches the display form attribute of the second information, the content written in the first information is regarded as having the content attribute of the second information, and
wherein the output unit outputs the content attribute of the first information as an item, and outputs the content written in the first information, as content corresponding to the item.

5. The information processing apparatus according to claim 4,
wherein, when first information corresponding to a component in the structure in the second information is not present, the output unit outputs the content attribute of the corresponding second information as an item, and outputs the content corresponding to the item, as a blank.

6. The information processing apparatus according to claim 4,
wherein the output unit outputs the plurality of pieces of first information to a storage unit, and
wherein, when a part, which has been blank, of the content of the item stored in the storage unit is filled in, the display controller newly displays the first information including the written content on the screen.

7. A non-transitory computer readable medium storing a program causing a computer to execute a process for information processing, the process comprising:
controlling display of first information disposed on a screen, and controlling display of second information illustrating an attribute of the first information; and
outputting a plurality of pieces of first information in accordance with a structure in the second information, the plurality of pieces of first information matching the second information in terms of the attribute and forming the structure.

8. An information processing apparatus comprising:
means for controlling display of first information disposed on a screen, and controlling display of second information illustrating an attribute of the first information; and
means for outputting a plurality of pieces of first information in accordance with a structure in the second information, the plurality of pieces of first information matching the second information in terms of the attribute and forming the structure.
